(19) United States
(12) Patent Application Publication
(10) Pub. No.: US 2007/0113061 A1
(43) Pub. Date: May 17, 2007

(54) System and method for coordinated startup of document processing service functions

(75) Inventor: Fabio Gava, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/272,857

(22) Filed: Nov. 14, 2005

(51) Int. Cl. G06F 15/177

(52) U.S. Cl. 713/1

(57) ABSTRACT

A method for coordinated startup of document processing service functions. The method begins with the retrieval of descriptor data for each of a plurality of document processing service functions. The descriptor data includes dependency data representing dependencies between document processing service functions. A startup sequence is then calculated for each of the document processing service functions according to the retrieved descriptor data. Next, the calculated startup sequence is outputted so as to commence a coordinated startup of each of the document processing service functions.

### BACKGROUND OF THE INVENTION

This invention is directed to a system and method for coordinated startup of document processing service functions. More particularly, this invention is directed to a system and method for synchronizing the start of selected document processing service functions in a document processing device so as to start in service function at the appropriate time in the minimal amount of time.

Document processing devices or multifunctional peripherals generally comprise a controller which controls the functions and operations of the device. The controller also controls the startup sequence for the device. The startup sequence of the document processing service must be determined based on the startup parameters and other settings such as service dependencies, for all of the services to be started. For example infrastructure services are required to be in service for the core services to operate, and therefore the infrastructure services must be started before the core services. In addition, the core services must be in service for the higher level services to operate, and must be in started and in service prior to the startup of the higher level services.

Therefore, a proper sequence for starting the various services must be determined such that the appropriate services are started and in service prior to the dependent services being started. Further, determining the appropriate sequence for starting the various services may not ensure a proper startup, as many of the services will require a certain amount of time to be loaded and initialize before the service is ready for operation. In addition, some services may have to perform lengthy tasks prior to another dependent service being started. As such, there is a need for a system and method for coordinated startup of document processing service functions.

The subject invention overcomes the above-noted limitations and provides a system and method for synchronizing the start of selected document processing service functions in a document processing device so as to start in service function at the appropriate time in the minimal amount of time.

### SUMMARY OF THE INVENTION

In accordance with the present invention, there is provided a system and method for coordinated startup of document processing service functions.

In accordance with the present invention, there is provided a system and method for synchronizing the start of selected document processing service functions in a document processing device so as to start in service function at the appropriate time in the minimal amount of time.

Further, in accordance with the present invention, there is provided for coordinated startup of document processing service functions. The system comprises means adapted for retrieving descriptor data for each of a plurality of document processing service functions, which descriptor data includes dependency data representative of dependencies between document processing service functions. The system also comprises calculation means adapted for calculating a startup sequence for each of the plurality of document processing service functions in accordance with retrieved descriptor data. The system further comprises sequence means adapted for outputting sequence data representative of a calculated startup sequence so as to commence a coordinated startup of each of the plurality of document processing service functions.

Still further, in accordance with the present invention, there is provided a method for coordinated startup of document processing service functions. The method comprises the steps of retrieving descriptor data for each of a plurality of document processing service functions, which descriptor data includes dependency data representative of dependencies between document processing service functions and calculating a startup sequence for each of the plurality of document processing service functions in accordance with retrieved descriptor data. The method further comprises the step of outputting sequence data representative of a calculated startup sequence so as to commence a coordinated startup of each of the plurality of document processing service functions.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for coordinated startup of document processing service functions in accordance with the present invention.

### DETAILED DESCRIPTION OF THE PREFERRED EMBODIMENT

This invention is directed to a system and method for coordinated startup of document processing service functions. More particularly, this invention is directed to a system and method for synchronizing the start of selected document processing service functions in a document processing device so as to start in service function at the appropriate time in the minimal amount of time. Preferably, the document processing device is a multifunctional peripheral device, capable of providing scanning, copying, facsimile, printing, document management, document storage, electronic mail, and other functions to a user.

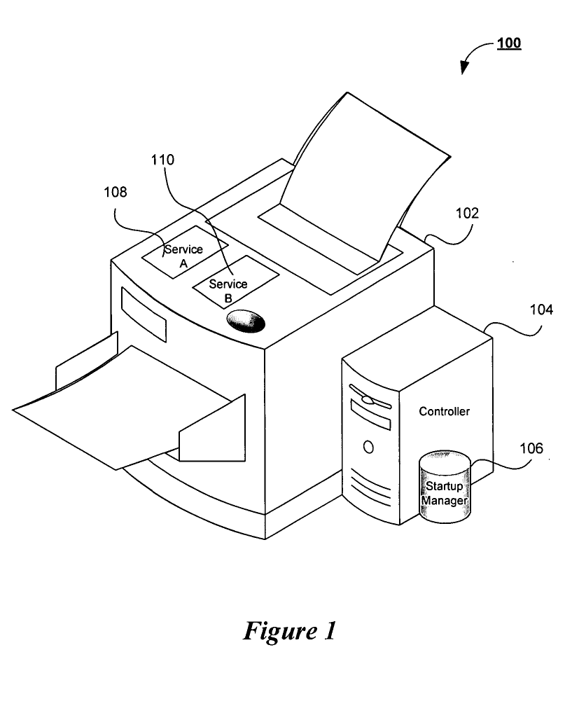

Turning now to FIG. 1, there is shown a block diagram illustrating a system 100 in accordance with the present invention. As depicted in the FIG. 1, the system 100 includes a document processing device 102. It will be appreciated by those skilled in the art that the document processing device 102 is advantageously represented in FIG. 1 as a multifunction peripheral device, capable of providing a variety of document processing services, such as for example and without limitation, printing, scanning, copying, facsimile, electronic mail, storage, and the like. Suitable commercially available document processing devices include, but are not limited to, the Toshiba e-Studio Series Controller. In one particular embodiment, the document processing device 102 is suitably equipped to receive a variety of portable storage media, with electronic data stored thereon, including, without limitation, Compact Flash, MMC, SD, XD, Firewire drives, USB drives, optical media, magnetic media, and the like.

The system 100 further includes a controller 104 communicatively coupled to the document processing device 102. As will be understood by those skilled in the art, the controller 104 is any hardware, software, or combination thereof, suitably adapted to facilitate the control of the document processing device 102. Such control is advantageously exercised over various software and hardware components of the document processing device 102, as are known in the art, such as for example and without limitation, optical character recognition, printer engines, modems, network interface cards, and the like. The controller 104 includes a startup manager component 106 suitably adapted to initialize all components that comprise the controller 104 software, including, without limitation, core components, infrastructure components, and higher-level components.

As will be understood by those skilled in the art, infrastructure services are basic services that are initialized first, as multiple other services require them in operation before being initialized. Suitable infrastructure services include, but are not limited to, a messaging daemon, which enables other components, or services, to communicate with each other via message exchange, pre-startup, which prepares the run-time environment, and the like. The skilled artisan will further appreciate that core services are basic services in nature, however the core services require one or more infrastructure services to already be in operation prior to being initialized. Suitable core services include, but are not limited to, an engine transport manager, which enables the data transfer between the controller 104 and the document processing device 102, a job manager, which manages document processing request workflows, a raster image processor manager, which renders a print data stream into a printer specific image format, and the like. Those skilled in the art will understand that higher-level services are document processing services, which require the prior activation of one or more infrastructure services and/or one or more core services. Such higher-level services include, for example and without limitation, a line printer daemon, a parallel print service, and TWAIN. It will be appreciated by those skilled in the art that a line printer daemon is suitably adapted to accept document processing requests submitted using a line printer protocol from network clients, a parallel print service is suitably adapted to accept document processing requests received from a client directly connected via a parallel port interface, and TWAIN enables the retrieval of images scanned by the document processing device 102 from network connected clients.

Those skilled in the art will appreciate that the various components are referred to generally herein as services, illustrated in FIG. 1 as service A 108 and service B 110. It will be understood by the skilled artisan that additional services are also capable of being controlled by the startup manager 106 of the controller 104 in accordance with the present invention, and the use of two services 108, 110 is for example purposes only. Each of the services 108, 110 are further capable of requiring the prior activation of one or more services, such that the services 108 and 110 cannot be activated until the preceding services are initialized. In the preferred embodiment, each of the services 108 and 110 include description data representative of document service functions. Each document service function is capable of having one or more dependencies, i.e., services that must be initiated prior to the first service, or alternatively are services that must be activated before subsequent document processing service functions are activated.

In accordance with the present invention, once the descriptor data has been retrieved, each dependent service, corresponding to each received document processing service, such as service A 108 and service B 110, is determined. This determination enables the manager 106 to calculate the exact startup sequence required to minimize the startup time for the services 108, 110 of the document processing device 102. Preferably, the calculations made by the manager 106 include allowing for delays in activation of a service, determining which of the services require immediate activation, and the like. The startup sequence is then loaded into the controller 104 for further processing.

The controller 104 analyzes the received startup sequence and initializes the first identified service. It will be understood by those skilled in the art that the controller 104 initiates the first service in the sequence via any means known in the art. When the first service designated by the sequence indicates that a delay is associated with the startup, i.e., that the service requires a longer period of initialization as compared to other services, the controller 104 awaits the receipt of a ready signal from the first service indicating successful startup. Once the first service is initialized, a ready signal is returned to the controller 104, enabling the controller 104 to begin the initialization of any subsequent services. Following receipt of the ready signal, the controller 104 proceeds to the next service in the sequence. It will be understood by those skilled in the art that the next service in the sequence is capable of depending from the first service, or alternatively, a service, which other, higher level services, require for their respective initializations. For example, those skilled in the art will appreciate that the line printer daemon, a higher-level component, requires the prior activation of the job manager, a core component, the raster image processor manager, a core component, and the engine transport manager, also a core component. These core components, in return, require that the messaging daemon infrastructure component, and the pre-startup infrastructure component, be operating.

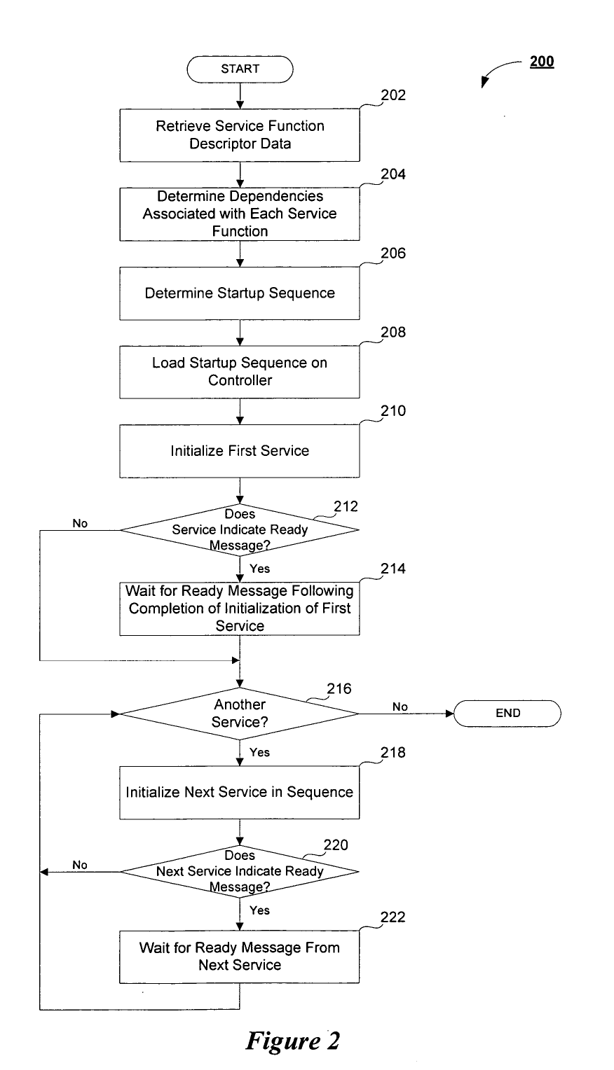

The controller 104 then begins the initialization process of the next service in the sequence and makes a determination whether this service also indicates a delay in startup warranting the controller 104 to await a ready signal. When the service indicates that a ready message is required, the controller 104 waits for the ready signal prior to initializing other dependent services, i.e., services that are dependent upon the service being initialized. It will be appreciated by those skilled in the art that the present invention is capable of multiple service startup, particularly when the multiple services are core services or infrastructure services, which have no inter-service dependencies. Once the ready signal of the current service is returned, the controller then determines whether any additional services remain in the sequence to be initialized. When the controller 104 determines that no additional services remain, the document processing device 102 via the controller 104, is ready to begin document processing operations. When the controller 104 determines that startup is complete, i.e., that no additional services remain in the sequence, the document processing device 102 is then ready for receipt of document processing requests. It will be appreciated by those skilled in the art that the pause in startup made by the controller in waiting for the ready signal prevents the waste of system resources by controlling the application of those system resources in an efficient manner. The system described above will better be understood in conjunction with the process illustrated in FIG. 2, discussed below.

Referring now to FIG. 2, there is shown a flowchart 200 illustrating a method for asynchronous startup in accordance with the present invention. Beginning at step 202, service function description data is retrieved by a startup manager 106. The startup manager 106 is any suitable hardware, software, or combination thereof, communicatively coupled to the controller 104 of an associated document processing device 102. Preferably, the startup manager 106 is suitably adapted to recover description data directly from the services sought to be initialized. The startup manager 106 of the controller 104 then determines the inter-service dependencies associated with each service function at step 204. It will be understood by those skilled in the art that the services of the document processing device include cross-dependencies, with one or more higher-level services requiring the prior initialization of core or infrastructure services. These cross-dependencies are analyzed by the startup manager 106 of the controller 104, which then determines at step 206 a sequence of initialization that minimizes startup time, while maximizing system performance.

The sequence determined by the startup manager 106 is then uploaded onto the controller 104 at step 208. At step 210, the controller 104 initializes the first sequence in the sequence list received from the startup manager 106. Preferably, the first sequence initialized is an infrastructure service, such as a pre-startup runtime environment service, from which other core and higher-level services depend. As previously discussed, in accordance with the present invention, a core service depends from one or more infrastructure services, and higher-level function services depend from one or more core services. At step 212, a determination is made by the controller 104 whether the first service indicates that a ready signal will be returned once the service is fully initialized. When such a ready signal is required, flow proceeds to step 214, wherein the controller 104 waits for the ready signal signifying completion of the initialization of the first sequence. When no ready signal is anticipated, or after such ready signal is received, flow proceeds to step 216.

At step 216, a determination is made whether any additional services remain in the sequence list for initialization. When no additional services remain to be initialized by the controller 104, the synchronous startup method terminates. When at least one additional service still requires startup prior to beginning document processing operations, flow proceeds to step 218, whereupon the next service in the sequence is initialized. It will be appreciated by those skilled in the art that such sequence is suitably capable of being an infrastructure, core, or higher-level service, depending upon where in the startup sequence the service is located, i.e., what prior initialized services the next service requires for initialization. Thus, at step 218 the next sequential service is initialized by the controller 104. Those skilled in the art will further appreciate that such a sequence is capable of depending from the first sequence, thereby requiring the initialization of the first sequence.

The controller 104 then determines, at step 220, whether the next service in the sequence indicates that a ready message will be returned following successful initialization. When no such ready message is indicated, flow returns to step 216, wherein the controller 104 determines whether any additional services, following the just initialized service, remain in the startup sequence. When additional services remain, flow continues to step 218 for initialization and a subsequent determination whether the service indicates a return ready message. Following a positive determination at step 220, flow proceeds to step 222, wherein the controller 104 awaits a ready signal indicating that the current service is fully initialized. Flow then returns to step 216 for a determination whether any additional services remain in the startup sequence. When no additional services remain, the controller 104 ends the startup process, as all necessary services for device 102 startup have been initialized and are available to the device 102 for performance of associated document processing operations.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for coordinated startup of document processing service functions comprising:
means adapted for retrieving descriptor data for each of a plurality of document processing service functions, which descriptor data includes dependency data representative of dependencies between document processing service functions;
calculation means adapted for calculating a startup sequence for each of the plurality of document processing service functions in accordance with retrieved descriptor data; and
sequence means adapted for outputting sequence data representative of a calculated startup sequence so as to commence a coordinated startup of each of the plurality of document processing service functions.

2. The system for coordinated startup of document processing service functions of claim 1 wherein the descriptor data further includes delay data representative of a time duration associated with startup of at least one of the plurality of document processing service functions.

3. The system for coordinated startup of document processing service functions of claim 1 further comprising:
means adapted for receiving a ready signal representative of a completed startup of a document processing service function; and
wherein the calculation means includes means adapted for calculating the startup sequence in accordance with a received ready signal.

4. The system for coordinated startup of document processing service functions of claim 2 wherein the delay data further includes data representative of a time duration for delaying processing of at least one of the plurality of document processing service functions, wherein the delay in processing is at least one of prior to startup of the document processing service function and after startup of the document processing service function.

5. The system for coordinated startup of document processing service functions of claim 1 wherein the document processing service functions include infrastructure services, core services, and higher level services.

6. The system for coordinated startup of document processing service functions of claim 5 wherein the infrastructure services include messaging daemon and pre-startup services.

7. The system for coordinated startup of document processing service functions of claim 5 wherein the core services include an engine transport manager, a job manager, and a raster image processing manager.

8. The system for coordinated startup of document processing service functions of claim 5 wherein the higher level services include a line printer daemon, a parallel print service, and TWAIN.

9. A method for coordinated startup of document processing service functions comprising the steps of:
retrieving descriptor data for each of a plurality of document processing service functions, which descriptor data includes dependency data representative of dependencies between document processing service functions;
calculating a startup sequence for each of the plurality of document processing service functions in accordance with retrieved descriptor data; and
outputting sequence data representative of a calculated startup sequence so as to commence a coordinated startup of each of the plurality of document processing service functions.

10. The method for coordinated startup of document processing service functions of claim 9 wherein the descriptor data further includes delay data representative of a time duration associated with startup of at least one of the plurality of document processing service functions.

11. The method for coordinated startup of document processing service functions of claim 9 further comprising the steps of:
receiving a ready signal representative of a completed startup of a document processing service function; and
calculating the startup sequence in accordance with a received ready signal.

12. The method for coordinated startup of document processing service functions of claim 10 wherein the delay data further includes data representative of a time duration for delaying processing of at least one of the plurality of document processing service functions, wherein the delay in processing is at least one of prior to startup of the document processing service function and after startup of the document processing service function.

13. The method for coordinated startup of document processing service functions of claim 9 wherein the document processing service functions include infrastructure services, core services, and higher level services.

14. The method for coordinated startup of document processing service functions of claim 13 wherein the infrastructure services include messaging daemon and pre-startup services.

15. The method for coordinated startup of document processing service functions of claim 13 wherein the core services include an engine transport manager, a job manager, and a raster image processing manager.

16. The method for coordinated startup of document processing service functions of claim 13 wherein the higher level services include a line printer daemon, a parallel print service, and TWAIN.

17. A computer-readable medium of instructions with computer-readable instructions stored thereon for coordinated startup of document processing service functions comprising:
instructions for retrieving descriptor data for each of a plurality of document processing service functions, which descriptor data includes dependency data representative of dependencies between document processing service functions;
instructions for calculating a startup sequence for each of the plurality of document processing service functions in accordance with retrieved descriptor data; and
instructions for outputting sequence data representative of a calculated startup sequence so as to commence a coordinated startup of each of the plurality of document processing service functions.

18. The computer-readable medium of instructions with computer-readable instructions stored thereon for coordinated startup of document processing service functions of claim 17 wherein the descriptor data further includes delay data representative of a time duration associated with startup of at least one of the plurality of document processing service functions.

19. The computer-readable medium of instructions with computer-readable instructions stored thereon for coordinated startup of document processing service functions of claim 17 further comprising the steps of:
instructions for receiving a ready signal representative of a completed startup of a document processing service function; and
instructions for calculating the startup sequence in accordance with a received ready signal.

20. A computer-implemented method for coordinated startup of document processing service functions comprising:
retrieving descriptor data for each of a plurality of document processing service functions, which descriptor data includes dependency data representative of dependencies between document processing service functions;
calculating a startup sequence for each of the plurality of document processing service functions in accordance with retrieved descriptor data; and
outputting sequence data representative of a calculated startup sequence so as to commence a coordinated startup of each of the plurality of document processing service functions.

21. The computer-implemented method for coordinated startup of document processing service functions of claim 20 wherein the descriptor data further includes delay data representative of a time duration associated with startup of at least one of the plurality of document processing service functions.

22. The computer-implemented method for coordinated startup of document processing service functions of claim 20 further comprising the steps of:
receiving a ready signal representative of a completed startup of a document processing service function; and
calculating the startup sequence in accordance with a received ready signal.
